(19) United States
(12) Patent Application Publication
(10) Pub. No.: US 2025/0116999 A1
(43) Pub. Date: Apr. 10, 2025

(54) COMPUTER-IMPLEMENTED METHOD AND SYSTEM FOR MANAGING LUMBER PRODUCTION LINE FLOW USING DEEP LEARNING AI, VISION, 3D AND ROBOTICS

(71) Applicant: BID GROUP TECHNOLOGIES LTD., Prince George (CA)

(72) Inventors: Diego dos Santos, Saint- Laurent (CA); Alexandre Prevost, Ottawa (CA); Guy Morissette, Lorraine (CA)

(21) Appl. No.: 18/482,416

(22) Filed: Oct. 6, 2023

(51) Int. Cl. G05B 19/418; G06T 7/00

(52) U.S. Cl. CPC G05B 19/41875; G05B 19/41865; G06T 7/0004; G06T 2207/30161

(57) ABSTRACT

The present invention introduces a saw line flow management method that incorporates deep learning AI, machine vision, 3D data, and robotics to monitor and maintain the smooth operation of a lumber production line in a sawmill or planer mill. By utilizing surveillance cameras and AI models, the system assesses board integrity, quality grading, and line flow anomalies. For a board evaluation, 3D data and AI deep learning models analyze live video feeds to detect major defects or positioning issues. Anomalies in the production line flow are identified using AI models applied to video feeds of the conveyor area. The system can trigger alarms and initiate human or robotic interventions to remove problematic boards or rectify flow disruptions.

### CROSS-REFERENCE TO RELATED APPLICATIONS

There are no cross-related applications.

### FIELD OF THE INVENTION

The present invention generally relates to computer-implemented methods and systems for managing lumber production line flows using deep learning artificial intelligence. More specifically, the method relates to monitoring and possibly taking corrective action on a lumber production line of a sawmill or planer mill. More specifically, the present invention relates to a method for managing a lumber production line that combines the use of an AI system, video cameras, and robotics.

### BACKGROUND OF THE INVENTION

In a sawmill or a planing mill, wood boards are produced in several cutting stages and phases. As wood is an organic material, unexpected behaviors can occur during the process. As a matter of fact, wood boards can break, for instance, and interfere with the normal flow of a lumber production line. In other circumstances, a bowed wood board could move out of its space, become skewed relative to its neighbors and, even worse, cross another board. Additionally, a mechanical failure can also happen and stop the production.

To correct hereinabove mentioned anomalies, the sooner the better. Sometimes, a simple undetected anomaly can escalate into a major production shutdown.

Since the advent of sawing production lines, humans have been responsible for monitoring and maintaining the consistency of the production line flow. In recent years, they have been helped by simple devices such as surveillance cameras and photo-eyes for instance. Widespread into sawmill, photo-eyes devices are helpful within their capabilities. Dirt and electrical problems often cause them to miss problems or trigger false alarms. On the other hand, video cameras are only providing views of the line and the entire monitoring task relies on human attention. As a result, lack of staff or inexperience of employees may result in problems not being detected in time.

There is thus a need for an improved method and system for managing lumber production line flows using deep learning artificial intelligence.

### SUMMARY OF THE INVENTION

The shortcomings of the prior art can be mitigated by using artificial intelligence (AI) technologies to assist and control production line monitoring process. In some aspects of the invention, a system to automate the process of monitoring the production line may comprise cameras, such as surveillance cameras already in place or new cameras to be installed.

In an aspect of the present invention, the method to automate the process of monitoring the production line may comprise a step to assess a board integrity and/or quality (grade). The method may further comprise a step for detecting any anomaly on the production line flow itself.

Such production lines generally transport lumber boards of different sizes and apply dimensional cuts and sorting. Since profitability depends on a smooth and/or continuous production flow, the method may comprise monitoring any anomalies that could stop or alter the flow of the production line and/or cause a production stoppage or at least may slow the production.

When an anomaly or a condition increasing the risk of stopping or altering the flow of the production line is detected, the method may comprise triggering an alarm for human intervention or a call for robot handling. In cases of robot handlings, the robot may be configured to remove one or more boards from the conveying or transport means aiming at unblocking the production line. In most cases, human intervention is generally required to supervise the operation and restart the production line after being unblocked.

In another aspect of the present invention, the method to automate monitoring of a production line aims at reducing downtime, minimizing false alarms, and enhancing workplace safety. The present invention generally aims at improving consistency and reliability compared to traditional human-dependent monitoring systems in lumber production lines.

The method to automate monitoring of a production line further aims at increasing consistency and reliability over a traditional human-operated system. The method and system to automate monitoring of a production line generally aims at reducing or eliminating false and missed alarms caused by prior art simplistic photo-eyes systems. The system and method generally aim at greatly reducing production downtimes of sawmills. Moreover, the reduction of production stoppages and the use of robots are a good way to reduce workplace accidents among personnel.

In yet another aspect of the invention, a computer-implemented method for automatically detecting anomalies of boards on a board production line using artificial intelligence (AI) is provided. The method comprises capturing a series of images of an area of the production line, identifying one or more boards in the captured images, performing automatic classification of attributes of the identified boards by inputting the captured images to an AI engine, based on the automatic classification, assessing the board as being a good piece or a bad piece, and performing an intervention on the production line to remove or move the board identified as a bad piece.

The method may further comprise automatically stopping the production line when the board is classified as bad and resuming the production line flow when the board identified as a bad piece has been removed.

The method may further comprise generating an alarm indicating that an anomaly was identified on the production line and resetting the alarm when the board identified as a bad piece has been removed. The method may further comprise not performing any intervention when the board is identified as a good piece.

The automatic classification may further comprise mapping in three dimensions (3D) the identified board, identifying a contour of the mapped board and determining the attributes of the mapped board based on the contour. The automatic classification may use one or more of the followings: position of the board on the production line, integrality of the board, alignment of the board, straightness of the board and integrity of the board.

The intervention may be a robotized intervention. The robotized intervention may further comprise picking and placing the board identified as a bad piece. The robotized intervention may further comprise removing from the production line the board identified as a bad piece.

In a further aspect of the invention, a computer-implemented method for automatically monitoring per board grade on a board production line using artificial intelligence (AI) is provided. The method comprises capturing a series of images of an area of the production line, identifying one or more boards in the captured images, performing automatic classification of by determining grade of the identified boards by inputting the captured images to an AI engine, based on the automatic classification, assessing the board as being a good piece when the determined grade is over to a predetermined threshold and as being a bad board when the determined grade is under the predetermined threshold and performing an intervention on the production line to remove or move the classified board.

The intervention may be a robotized intervention. The robotized intervention may further comprise picking and placing the classified board. The automatic classification may further comprise mapping in three dimensions (3D) the identified board, identifying a contour of the mapped board and determining the attributes of the mapped board based on the contour. The automatic classification may use one or more of the followings criteria: grade of the board, color of the board and number and size of natural defects of the board.

The method may further comprise conveying the board classified as a good piece to a grade bin of a sorter.

In another aspect of the invention, a computer-implemented method for automatically monitoring line flow of a board production line using artificial intelligence (AI) is provided. The method comprises capturing a series of images of a flow of boards of the production line, identifying the boards in the flow in the captured images, performing automatic classification of the flow of the identified boards by inputting the captured images to an AI engine, based on the automatic classification, assessing the flow of boards as being a normal flow or as comprising anomalies and performing an intervention on the production line when the flow is classified as having an anomaly.

The intervention may be a robotized intervention. The robotized intervention may further comprise any one of the followings: retrieving a board from the flow comprising an anomaly from the production line, picking one or more boards causing the anomaly from the production line and placing the picked board in order to revert to a normal flow of the production line and directing one or more boards causing the anomaly to a stacker.

The automatic classification may use one or more of the followings criteria: speed of the production line and linearity of the production line.

The method may further comprise automatically stopping the production line when the flow is classified as comprising an anomaly and resuming the production line flow when the board identified one or more of the boards causing the anomaly has been removed.

The method may further comprise generating an alarm indicating that an anomaly was identified on the flow of the production line and resetting the alarm when one or more boards identified as causing the anomaly has been removed.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a flow chart of an embodiment of a method to automate per board anomaly monitoring process of a production line using robotized intervention according to the principles of the present invention.

FIG. 2 is a flow chart of an embodiment of a method to automate per board grade monitoring process of a production line using robotized intervention according to the principles of the present invention.

FIG. 3 is a flow chart of an embodiment of a method to automate line flow board monitoring process of a production line using human intervention according to the principles of the present invention.

FIG. 4 is a perspective drawing of an embodiment of a system to automate board monitoring of a production line according to the principles of the present invention.

FIG. 5 is a drawing of an embodiment of a system to automate board monitoring of a production line seen from the front according to the principles of the present invention.

FIG. 6 is a drawing of an embodiment of a system to automate board monitoring of a production line seen from the top according to the principles of the present invention.

FIG. 7 is a drawing of an embodiment of a system to automate board monitoring of a production line seen from the side according to the principles of the present invention.

FIGS. 8, 9 and 10 are exemplary images of skew boards anomalies identified using a system to automate per board anomaly monitoring process of a production line according to the principles of the present invention.

FIGS. 11 and 12 are exemplary images of double board anomalies identified using a system to automate per board anomaly monitoring process of a production line according to the principles of the present invention.

FIGS. 13 and 14 are exemplary images of trim block anomalies identified using a system to automate per board anomaly monitoring process of a production line according to the principles of the present invention.

FIGS. 15 and 16 are exemplary images of offset anomalies identified using a system to automate per board anomaly monitoring process of a production line according to the principles of the present invention.

### DETAILED DESCRIPTION OF THE INVENTION

Novel computer-implemented method and system for managing saw lumber production line flow management method using deep learning ai, vision, 3d and robotics will be described hereinafter. Although the invention is described in terms of specific illustrative embodiments, it is to be understood that the embodiments described herein are by way of example only and that the scope of the invention is not intended to be limited thereby.

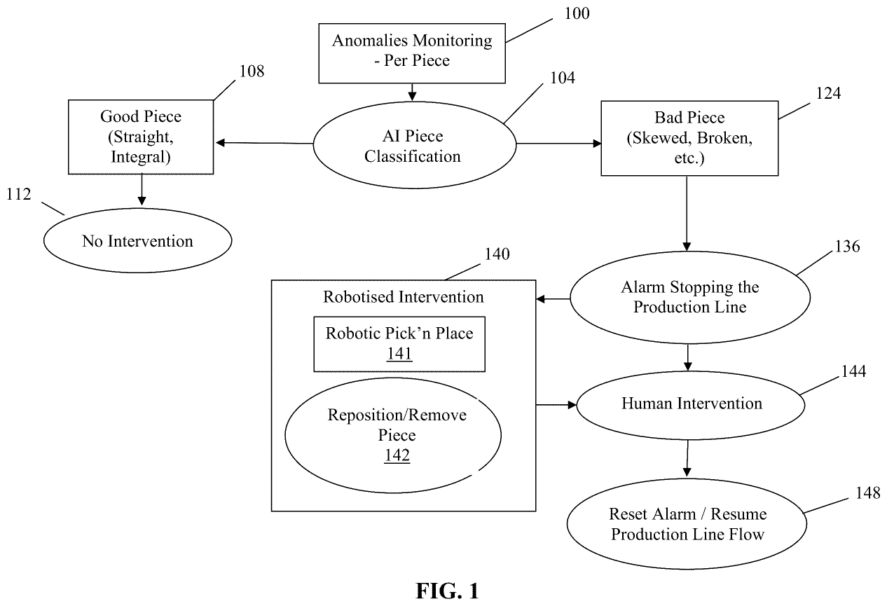

First referring to FIG. 1, an embodiment of a method to automate board monitoring process of a production line using robotized intervention is illustrated as a flow chart. In such embodiment, the method 100 monitors each of the boards or pieces of wood conveyed on the production line to monitor anomalies. The method 100 comprises performing classification of the boards or pieces of wood assisted with AI 104. The classification 104 assesses the board as being a good piece 108 or a bad piece 124. As an example, a piece of wood can be classified as a good 108 when the said piece is straight and/or integral. The piece of wood may further be classified as bad 124 when the board is skewed, broken or comprises any other anomaly. When the board is being classified as good 108, no intervention is performed 112. In some embodiment, the board may be conveyed to a sorter or to any other 116. When the board is being classified as bad 124, the method may comprise generating an alarm and/or automatically stopping the production line 136. Following the triggering of the alarm 136, the method may comprise performing a robotized intervention on the production line to remove or move the bad board 140 and/or wait for a human intervention to be performed on the production line 144. The method then comprise resetting the alarm and/or resuming the production line flow 148. In some embodiments, the robot is configured to pick and place the board 141 and/or to remove or reposition the picked bad board 142.

Still referring to FIG. 1, the method to monitor each of the boards 100 may further comprise providing an individual board to be introduced in the saw mill production line, saw line, or production line. In some embodiments, the individual board monitoring process 100 may be performed at each appropriate viewpoint. As such, the method 100 may further comprise analyzing video samples and a user or operator using an interface for tagging a plurality of visible boards as being good or bad.

The board monitoring process may further comprise mapping in 3D the board being processed. The 3D mapping may further comprise determining the physical shape of the real or potential blockage 3D sensors and/or AI image analysis from the AI system. The determined shape may comprise a broken board or other types of debris. In some embodiments, the 3D sensors are positioned or distributed along the production line. In some embodiments, the 3D sensors are placed around a specific area that is known by the operator to experience more blockage in the production line.

The AI classification step 104 may use various predetermined criteria such as the position of the board in the production line, the integrality of the board, the alignment of the board, the straightness of the board and/or the integrity of the board. Understandably, in other embodiments, the classification step 104 may use other criteria which may be captured using other sensors and/or detectors. Each board being conveyed on the production line is evaluated and, according to values of the predetermined criteria, labeled as good or bad.

In some embodiments, the system comprises a video camera or several camera videos positioned to capture a video stream of different viewpoints of the production line. The AI system is configured to analyze in real-time or near real-time live video feed captured by the video camera. The classification step 104 may further comprise classifying the boards detected in the videos for a given viewpoint using a deep learning AI model. The deep learning AI model is trained to tag a board being conveyed on the production line as good and bad.

To be categorized, a board may be associated with a grade quality which may depend on the final application.

In some embodiments, the operator may choose and implement pre-determined settings in the AI system to specifically sort out a type of board. The pre-determined setting may be set prior to the step of pre-monitoring 100. For example, a threshold in terms of quality grade for what is deemed to be a good board is decided by the operator and implemented in the AI system based on the desired application of the board. In some embodiments, the operator may change the settings during operations of the production line.

When the board is classified as being good or as meeting predetermined criteria, the method may comprise the production line resuming or continuing the flow of boards without any automated or human intervention 112. As such, a good board may be graded and removed or simply left untouched on the conveyor means. Therefore, the good board is left on the production line.

The method 100 may further comprise triggering an alarm and stopping the production line 136. The alarm is triggered to require human intervention 144 or to call for robot handling 140 when the AI system detects a bad board 124.

Still in the event of a board being classified as bad 124, the robot may intervene or be actioned to correct the position of the bad board on the production line 140. In some embodiments, the robot is configured to pick and place the board 141 and/or to remove or reposition the picked bad board 142.

The method 100 may further comprise a human intervention 144 to replace one or more boards and may further comprise resetting the alarm and resuming the production line flow 148.

In the case of a robotic intervention, the AI system in conjunction with the robots assesses in which order to retrieve one or more boards from the production line.

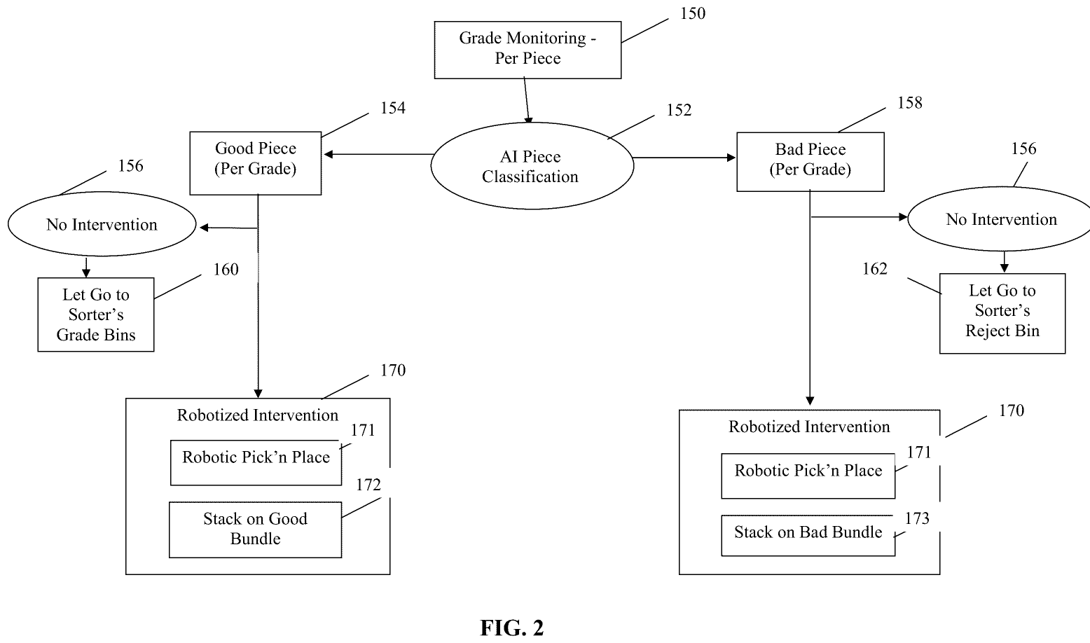

Referring now to FIG. 2, an embodiment of a method to automate per board grade monitoring process of a production line using robotized intervention 150 is illustrated. Broadly, the method 150 comprises classification of piece of wood or a board using AI 152. AI is configured to identifying

As for the method 100, the grade board monitoring process 150 may further comprise mapping in 3D the board being processed.

The AI classification step 152 may use various predetermined criteria such as the grade of the board, the color of the board, the number and size of knots, natural defects, etc. Understandably, in other embodiments, the classification step 104 may use other criteria which may be captured using other sensors and/or detectors. Each board being conveyed on the production line is evaluated and, according to values of the predetermined criteria, labeled as having a good or bad grade.

As an example, a piece of wood can be classified as being a good piece per grade 154 when the said piece has the acceptable or desired grade. The piece of wood may further be classified as being a bad piece 158 when the AI classification identifies the board as having an unacceptable or undesired grade. When the board is being classified as good 154, two paths are possible, either no intervention is performed 156 and the board is conveyed to a grade bin of a sorter 160. In other cases, the method 150 may comprise performing a robotized intervention 170. The robotized intervention may comprise picking and placing the good piece 171 and/or stacking the good piece on a good bundle 172.

When the board is being classified as bad 158, two paths are possible, either no intervention is performed 156 and the board is conveyed to a reject bin of the sorter 162. In other cases, the method 150 may comprise performing a robotized intervention 170. The robotized intervention may comprise picking and placing the bad piece 171 and/or stacking the bad piece on a bad bundle 173.

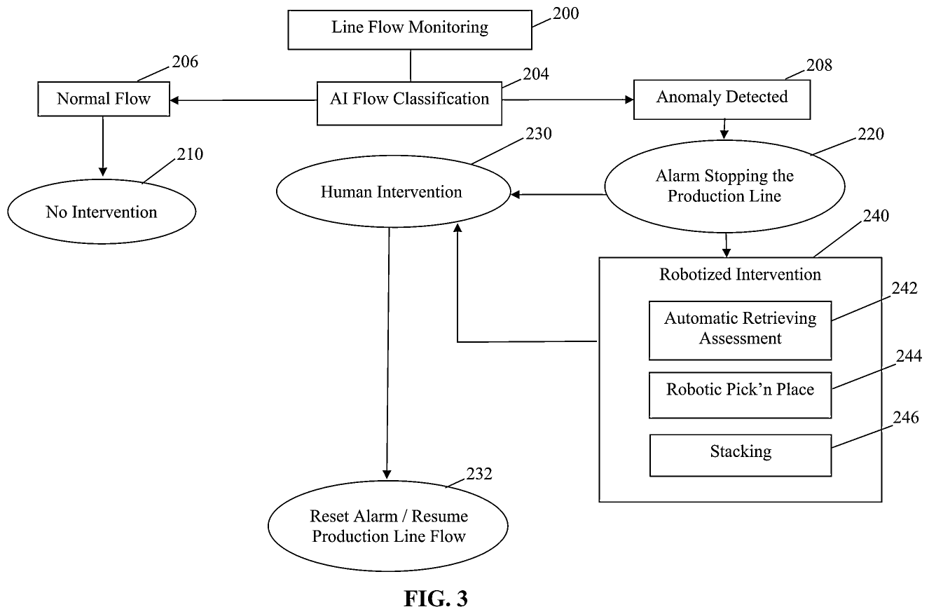

Referring to FIG. 3, another embodiment of a method to automate a line flow monitoring process of a board production line using human intervention 200 is illustrated as a flow chart. FIG. 3 broadly illustrates the production line monitoring process, production line flow monitoring process, or wood flow monitoring process. The method 200 generally comprises monitoring each of the flows of boards conveyed on the one or more production lines. The method comprises performing classification of a flow of boards being conveyed using AI 204. The flow classification step 204 assesses the flow of boards of the production line as being normal 206 or as comprising one or more anomalies 208. When the flow is classified as normal 206, no intervention is performed 210. As such, the flow continues on the production line as usual. When an anomaly is detected in the flow of boards 208, the method may comprise generating an alarm and/or automatically stopping the production line 220. When the alarm or the production line is stopped 220, the method may wait for a human intervention 230 and/or a robotized intervention 240 on the conveyor to restore the flow of the production line.

Similarly to the method to automate a per board monitoring process 100, the method 200 comprises classification assisted with AI 204. The classification comprises executing AI deep learning models from the AI system on captured video feeds or video live feeds. The video feeds generally capture the conveyor area of the production line. The AI system is trained with normal flow images of the production line as well as images containing problematic situations during the production process.

The AI deep learning model is configured to detect any anomalies occurring on the production line (e.g., skewed boards on the production line, crossed boards, broken pieces of wood, etc.). Color or grayscale video data and or 3D data are collected from one or more viewpoints from video cameras set along the production line.

In some embodiments, the method 200 is performed in real time by receiving classification information from the AI system.

The method 200 further comprises using the AI system to classify the production line flow depending on the speed and the linearity of the flow 204. If the production line flow is classified as normal by the AI system 206, no intervention is performed on the production line 210.

If the flow is classified as comprising an anomaly 208, the method 20 comprises triggering an alarm and stopping the production line 220. The method 200 may be performed or applied on a live production saw line. In such embodiments, the method 200 comprises, using the trained AI deep learning models to trigger an alarm and to stop the production line in case where an anomaly is detected 220 on the production line flow.

Upon triggering an alert and stopping the production line 220, two types of interventions may be performed by the method 200 depending on the settings applied for the production line monitoring process. In some embodiment, when a human performed an intervention to correct the one or more anomalies 230, the method 200 comprises resetting the alarm of the production line and resuming operations of the production line flow 232. In some embodiments, the resetting and resuming operations 232 may be performed manually, such as by an operator.

In yet other embodiments, the method may comprise using a robotized arm or machine to correct or remove the anomaly from the production flow 240. The robotized arm may be configured or programmed to automatically retrieve the board or element that disrupts the normal flow of the production line and triggered the anomaly detection process in the production line 208.

The step to use the robotized arm 240 may further comprise using the AI system to automatically assess if and how the board disrupting operations of the production line 242 may be retrieved from the conveyor or other transportation means. In yet other embodiments, the robotized arm may be configured or programmed to pick one or more boards causing the anomaly and to place the picked board in order to maintain a corrected flow of production 244. The robotized arm may further be configured to direct or move the board causing the anomaly to the stacker 246.

The method 200 may further comprise restarting the production line 232 after the production line was stopped 220 may be performed automatically or via a human intervention 230. In some embodiments, the AI system is able to resume to production line flow under certain conditions predetermined by the operator.

The AI system may be in data communication with the video cameras installed over the production line and be configured to receive a stream or images from the said cameras. The methods 100, 150 and/or 200 use the data received from the cameras to classify the boards as good or bad or to assess quality of the flow of the production line. In some embodiments, the methods 100, 150 and/or 200 may use a plurality of video feeds.

A different camera feed may be positioned to obtain a viewpoint of the production line. For each viewpoint, the visible anomaly may be labeled by a user or operator. In some embodiments, for convenience purpose, a synthetized production saw line simulation can be used to create anomalies and feed a deep learning AI model for training purposes. A deep learning AI model is then built to detect any anomaly in any production line video for a given viewpoint.

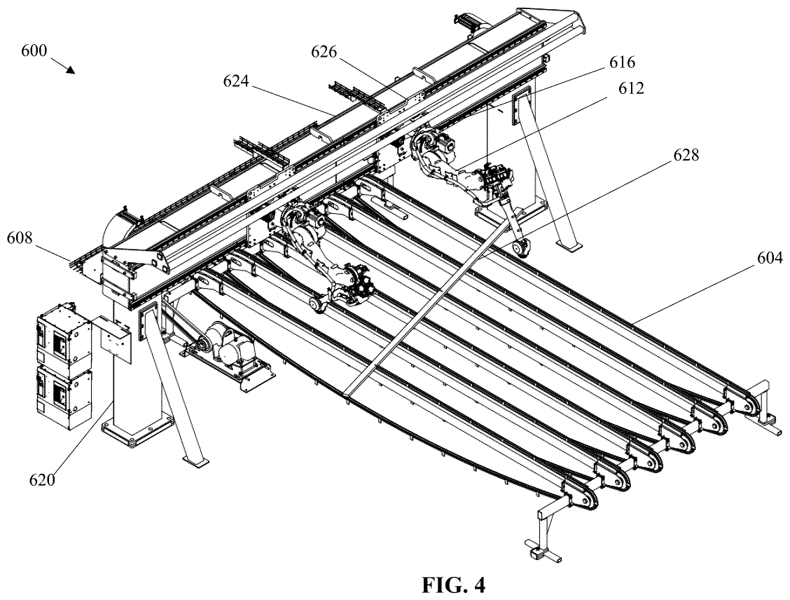

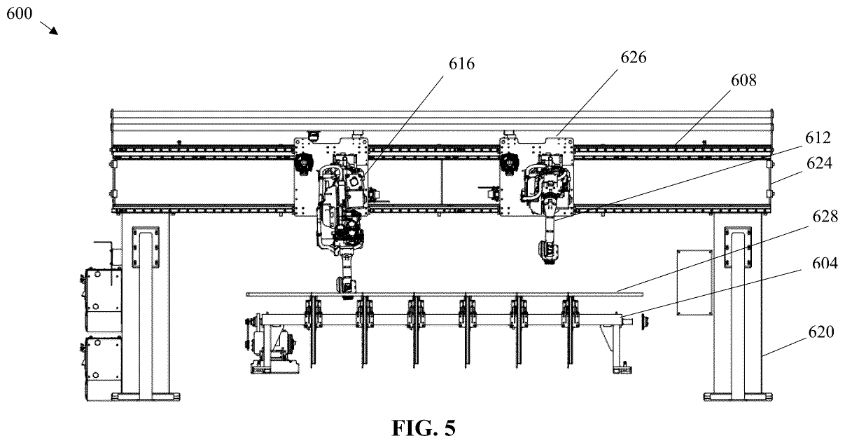

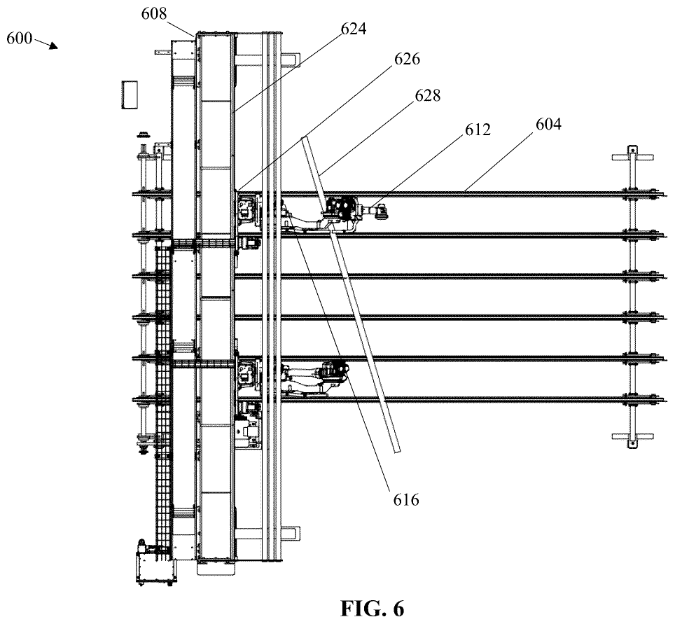

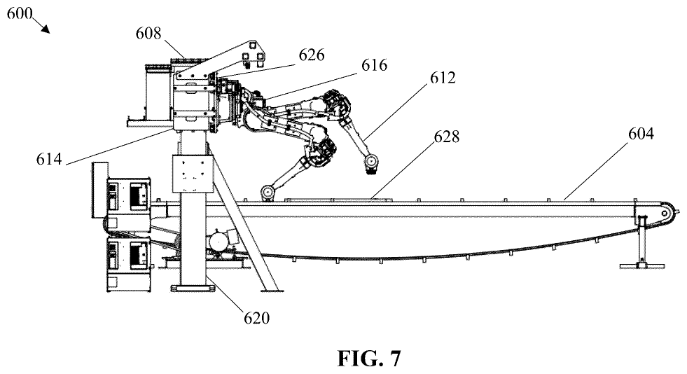

Referring now to FIGS. 4 to 7, a system to automate flow and per-board monitoring process of a board production line 600 is illustrated. The system 600 comprised a computer or server, one or more cameras or sensors 616 positioned to capture a viewpoint of the production line and a computer program configured to be executed by the computer. The cameras or sensors 616 are in data communication with the computer or server to provide a video feed of the production line. The computer program comprises instructions to build and train a deep learning AI model for detecting anomalies of the production line and/or to detect defective or blocking position of boards on the production line. The server is further configured to execute the trained AI model on the camera feeds to detect anomalies or blocking boards on the production line. The computer or server is further in data communication with a controller of the production line configured to stop and start operations of the production line and to retrieve status of the production line in real time. The computer or server may further be configured to send a request to the controller to stop or start the production line.

The computer/server may further be in data communication with the robotized arm 612. Based on the video stream and on the assessment from the AI model, the computer may be configured to calculate position of the board or the anomaly and to send commands to the robotized arm to pick a board at the calculated position. Any known method for a robotized arm 612 to pick and drop a board may be used within the scope of the present invention.

Still referring to FIGS. 4-7, an exemplary embodiment of the production line with the monitoring board system 600 is illustrated. The system 600 comprises a conveyor or transporting means 604, such as a conveyor operated by belt or chain, a gate structure 608, a robotized arm 612, and one or more video or image sensors 616. The conveyor belt 604 passes under the gate structure 608. In the illustrated embodiment, the frame 608 comprises two vertical posts or pillars 620 and a horizontal top portion or crosspiece 624. The horizontal portion 624 is supported at each end by the two vertical posts 620. As illustrated, the conveyor means 604 is typically positioned in-between the two vertical posts 620.

The one or more robotized arms 612 are pivotally and slidably mounted to the top portion 624 of the frame 608. In the illustrated embodiment, each of the robotized arms 612 are mounted over a conveyor means 604, each of the conveyor means 604 being a production line. Each robotized arm 612 may be mounted to a plate 626. The plate 626 may be slidably mounted to the frame 608 to allow horizontal movement of the robotized arm 612 over the conveyor means 604. Understandably, any means to allow horizontal movement of the robotized arm 612 may be used within the scope of the present invention.

The robotized arm 612 overhangs over a predetermined monitoring area of the conveyor belt 604. A video sensor or capturing device 616, such as a video camera, is mounted to the plate 626 and thus follows movement of the robotized arm 612 with regard to the conveyor means 604. Each camera 616 oversees the passage of wood boards 628 in the monitoring area.

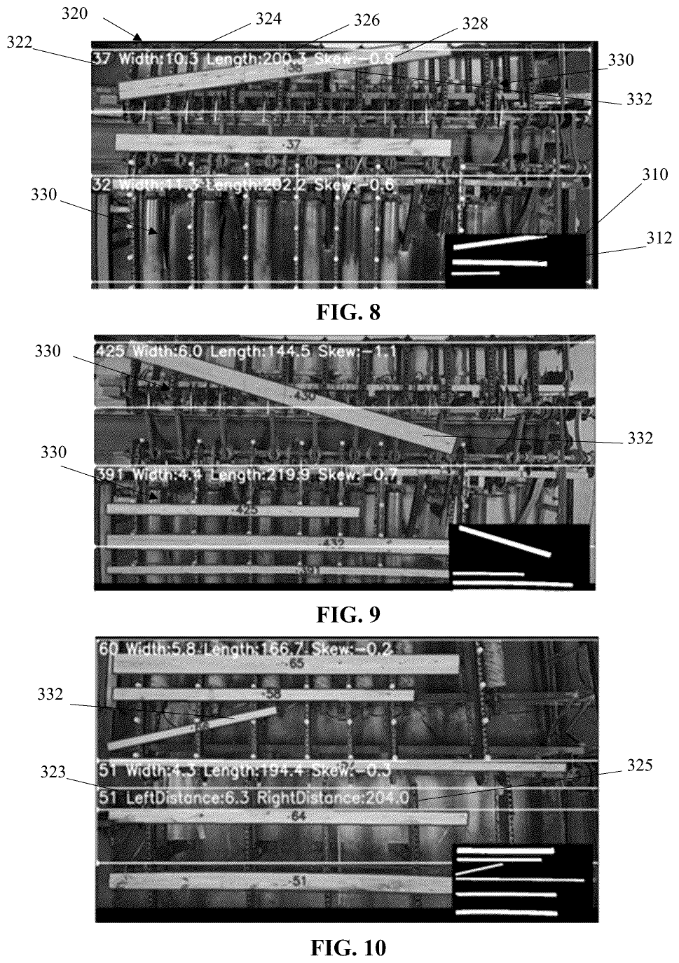

Referring now to FIGS. 8-16, exemplary anomalies that may occur in the production line are illustrated by photographs analyzed by the methods 100, 150 and/or 200. In such figures, the shapes or contours of boards 312 are identified by the AI system in the bottom right quadrant 310. Understandably, any other means to shown the contours of the boards 312 is within the scope of the present invention. The system is further configured to identify other characteristics 320 of the boards captured on the conveyor. The system may assign an identification number 322 to the analyzed board. The characteristics may also include, but are not limited to, the width of the board 324, length of the board 326, the skew factor 328, the left distance 323 and/or the right distance 325. As illustrated, the system identifies the general rectangular contour 330 of the conveyor area where the board is present. As such, many contour areas 330 may be illustrated in each image, as seen in FIGS. 8 to 16.

Referring to FIGS. 8 to 10, one or more boards 332 are shown being identified as being skewed, not straight, twisted or distorted. Referring to FIG. 8, the exemplary board identified as no. 37 has a width of 10.3, a length of 200.3 and a skewness of about 0.9.

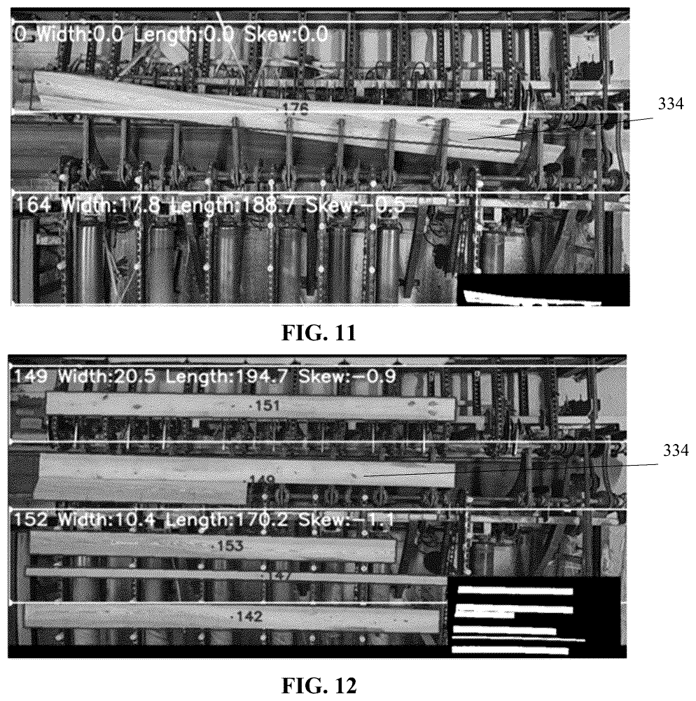

Referring to FIGS. 11 and 12, one or more boards 334 are shown being identified as double board anomaly. In such example, two boards are too close to one another or are overlapping.

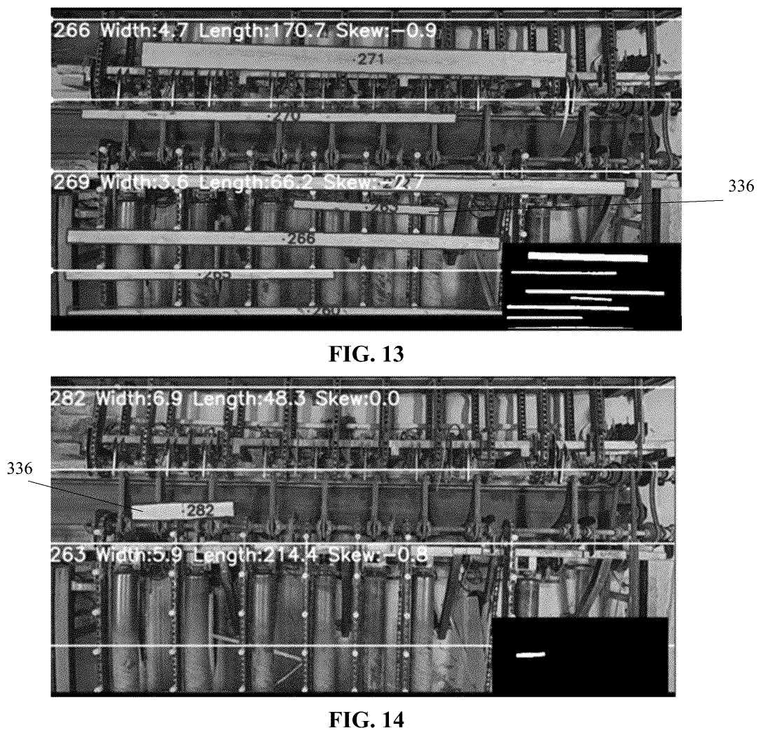

Referring to FIGS. 13 and 14, the presence of a trim block 336 anomaly is identified by the system. As such the length of the analyzed board 332 may be inferior or equal to a predetermined value. Referring to FIG. 13, the board identified as no. 269 as a length of 66.2, which is under a predetermined value of the system.

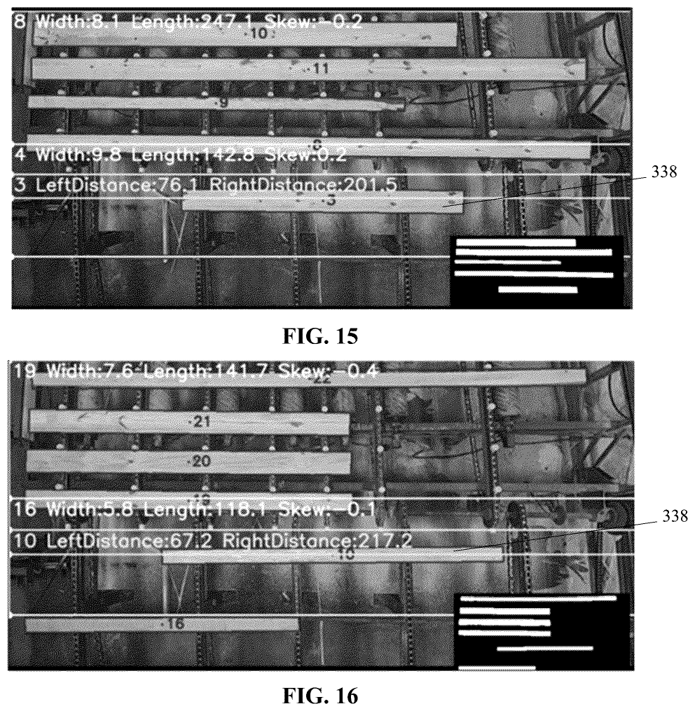

Referring to FIGS. 15 and 16, one or more boards 338 are shown being identified as offset. The one or more identified boards 338 are shown as having a left distance 323 being over a predetermined value. Understandably, in some embodiments, the system could be configured to detect boards being offset from the right end, as such using the right distance 325 as an indicator.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A computer-implemented method for automatically detecting anomalies of boards on a board production line using artificial intelligence (AI), the method comprising:
capturing a series of images of an area of the production line;
identifying one or more boards in the captured images;
performing automatic classification of attributes of the identified boards by inputting the captured images to an AI engine;
based on the automatic classification, assessing the board as being a good piece or a bad piece; and
performing an intervention on the production line to remove or move the board identified as a bad piece.

2. The computer-implemented method of claim 1 further comprising:
automatically stopping the production line when the board is classified as bad; and
resuming the production line flow when the board identified as a bad piece has been removed.

3. The computer-implemented method of claim 1 further comprising:
generating an alarm indicating that an anomaly was identified on the production line; and
resetting the alarm when the board identified as a bad piece has been removed.

4. The computer-implemented method of claim 1 further comprising not performing any intervention when the board is identified as a good piece.

5. The computer-implemented method of claim 1, the automatic classification further comprising mapping in three dimensions (3D) the identified board, identifying a contour of the mapped board and determining the attributes of the mapped board based on the contour.

6. The computer-implemented method of claim 1, the automatic classification using one or more of the followings: position of the board on the production line, integrality of the board, alignment of the board, straightness of the board and integrity of the board.

7. The computer-implemented method of claim 1, the intervention being a robotized intervention.

8. The computer-implemented method of claim 7, the robotized intervention further comprising picking and placing the board identified as a bad piece.

9. The computer-implemented method of claim 7, the robotized intervention further comprising removing from the production line the board identified as a bad piece.

10. A computer-implemented method for automatically monitoring per board grade on a board production line using artificial intelligence (AI), the method comprising:
capturing a series of images of an area of the production line;
identifying one or more boards in the captured images;
performing automatic classification of by determining grade of the identified boards by inputting the captured images to an AI engine;
based on the automatic classification, assessing the board as being a good piece when the determined grade is over to a predetermined threshold and as being a bad board when the determined grade is under the predetermined threshold; and
performing an intervention on the production line to remove or move the classified board.

11. The computer-implemented method of claim 10, the intervention being a robotized intervention.

12. The computer-implemented method of claim 11, the robotized intervention further comprising picking and placing the classified board.

13. The computer-implemented method of claim 10, the automatic classification further comprising mapping in three dimensions (3D) the identified board, identifying a contour of the mapped board and determining the attributes of the mapped board based on the contour.

14. The computer-implemented method of claim 10, the automatic classification using one or more of the followings criteria: grade of the board, color of the board and number and size of natural defects of the board.

15. The computer-implemented method of claim 10 further comprising conveying the board classified as a good piece to a grade bin of a sorter.

16. A computer-implemented method for automatically monitoring line flow of a board production line using artificial intelligence (AI), the method comprising:
capturing a series of images of a flow of boards of the production line;
identifying the boards in the flow in the captured images;
performing automatic classification of the flow of the identified boards by inputting the captured images to an AI engine;
based on the automatic classification, assessing the flow of boards as being a normal flow or as comprising anomalies; and
performing an intervention on the production line when the flow is classified as having an anomaly.

17. The computer-implemented method of claim 16, the intervention being a robotized intervention.

18. The computer-implemented method of claim 17, the robotized intervention further comprising any one of the followings:
retrieving a board from the flow comprising an anomaly from the production line;
picking one or more boards causing the anomaly from the production line and placing the picked board in order to revert to a normal flow of the production line; and
directing one or more boards causing the anomaly to a stacker.

19. The computer-implemented method of claim 16, the automatic classification using one or more of the followings criteria: speed of the production line and linearity of the production line.

20. The computer-implemented method of claim 16 further comprising:
automatically stopping the production line when the flow is classified as comprising an anomaly; and
resuming the production line flow when the board identified one or more of the boards causing the anomaly has been removed.

21. The computer-implemented method of claim 16 further comprising:
generating an alarm indicating that an anomaly was identified on the flow of the production line; and
resetting the alarm when one or more boards identified as causing the anomaly has been removed.
